(19) United States
(12) Patent Application Publication
(10) Pub. No.: US 2010/0100598 A1
(43) Pub. Date: Apr. 22, 2010

(54) TERMINAL APPARATUS AND METHOD FOR TRANSMITTING DATA IN TERMINAL APPARATUS

(75) Inventor: Hiroaki SATO, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/561,441

(22) Filed: Sep. 17, 2009

(30) Foreign Application Priority Data
Oct. 21, 2008 (JP) P2008-270928

(51) Int. Cl. G06F 15/16

(52) U.S. Cl. 709/206

(57) ABSTRACT

According to an aspect of the present invention, a terminal apparatus includes: a limiting module that determines a limiting data size that is receivable data size by a destination terminal of a mail from the terminal apparatus; a editing module that generates a plurality of scenes from an original file to be send when data size of the mail including the original file is larger than the limiting data size; and a sending module that combines the generated scenes so that the data size does not exceed the limiting data size and sends the mail including the combined scene.

### CROSS-REFERENCE TO RELATED APPLICATIONS

This application is based upon and claims the benefit of priority from Japanese Patent Application No. 2008-270928, filed Oct. 21, 2008, the entire contents of which are incorporated herein by reference.

### BACKGROUND

1. Field

The present invention relates to a terminal apparatus in which the data amount of an attachment file of an e-mail is limited and a method for transmitting data thereof.

2. Description of the Related Art

Among examples in which the data amount of a moving image file is limited is a moving image extraction apparatus capable of limiting the data amount in uploading a moving image over the Internet (refer to JP-A-2005-108193 (pages 1-6, FIGS. 1-5), for example). In this moving image extraction apparatus, limit capacity value is acquired from a server on the Internet and a section, corresponding to the limit capacity value, of a moving image file is displayed on the screen. The user shifts the section arbitrarily and thereby specifies a desired section, and the apparatus generates a new moving image file of the specified section and uploads it.

Although the moving image extraction apparatus of JP-A-2005-108193 can generates a new moving image file of one arbitrarily extracted section corresponding to a limit, capacity from a moving image file, it cannot collect sections that are separated from each other. In general, favorite scenes of the user or scenes that user wants others to see do not necessarily continue and are in many cases separated from each other. Furthermore, the capacity limitation is imposed by a server when a file is uploaded over the Internet.

Incidentally, as for mail communication from a terminal apparatus, there are capacity limitation due to a limit capacity of a transmission source contract communication company, capacity limitation due to a limit capacity of destination person contract communication company, and other kinds of capacity limitation. It is difficult for the user to recognize those kinds of limitation and send a mail that satisfies a resulting limit capacity.

### SUMMARY OF THE INVENTION

According to an aspect of the present invention, there is provided a terminal apparatus including: a limiting module that determines a limiting data size that is receivable data size by a destination terminal of a mail from the terminal apparatus; a editing module that generates a plurality of scenes from an original file to be send when data size of the mail including the original file is larger than the limiting data size; and a sending module that combines the generated scenes so that the data size does not exceed the limiting data size and sends the mail including the combined scene.

### BRIEF DESCRIPTION OF THE SEVERAL VIEWS OF THE DRAWINGS

FIG. 1 is a block diagram of a terminal apparatus 100 according to an exemplary embodiment.

FIGS. 2A to 2C illustrate editing of moving image files according to the exemplary embodiment.

FIG. 3 is a flowchart showing the operation of a moving image file edit function 21 of the terminal apparatus 100 according to the exemplary embodiment.

FIG. 4 is a flowchart showing the operation of a mail control function 11 of the terminal apparatus 100 according to the exemplary embodiment.

### DETAILED DESCRIPTION

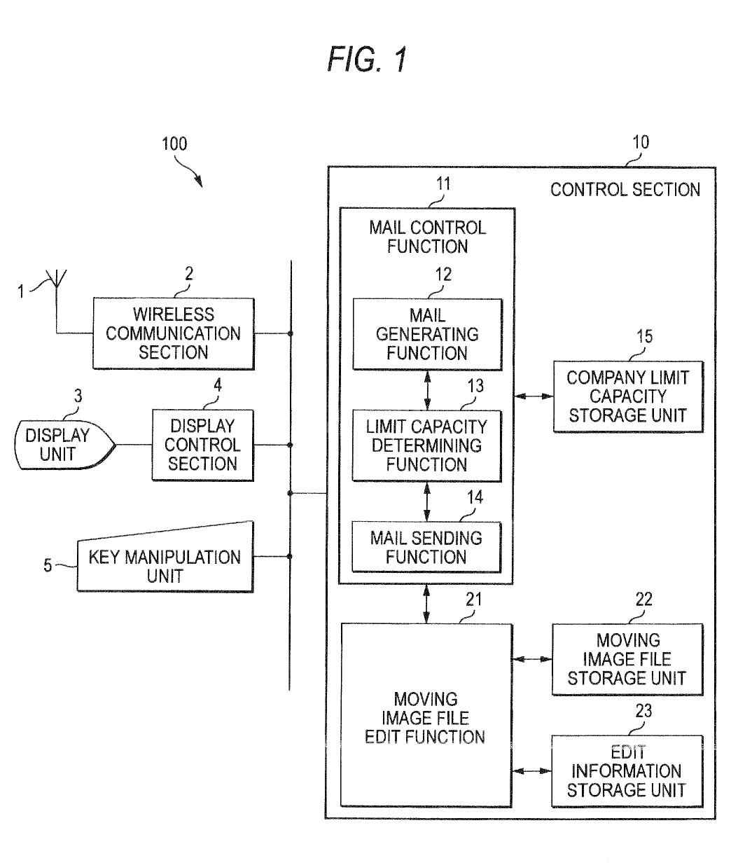

FIG. 1 is a block diagram of a terminal apparatus 100 according to an embodiment of the present invention. The terminal apparatus 100 is composed of an antenna 1, a wireless communication section 2, a display unit 3, a display control section 4, a key manipulation unit 5, a control section 10, etc.

The control section 10, which is composed of a CPU, a ROM, a RAM, etc. (not shown), performs a mail control function 11, a moving image file edit function 21, etc. according to software stored in the ROM. The mail control function 11 has and performs a mail generating function 12, a limit capacity determining function 13, and a mail sending function 14. The control section 10 has, as storage means, a company limit capacity storage unit 15, a moving image file storage unit and an edit information storage unit 23.

Next, the individual constituent elements will be described. The antenna 1 is a wireless communication antenna. The wireless communication section 2 performs frequency conversion, modulation/demodulation, etc. on a radio signal and also performs communication (transmission/reception) processing on mail data etc. The display unit 3 is an LCD, for example. The display control section 4, which is a display controller for the display unit 3, controls display data according to the form of the display unit 3 and sends resulting data to the display unit 3. The key manipulation unit 5 includes user manipulation keys.

Constituent elements relating to a mail control function of the invention are the mail control function 11 and the company limit capacity storage unit 15. The mail generating function 12 of the mail control function 11 processes user interfaces for specification of a mail destination, mail generation, designation of an attachment file, etc. The limit capacity determining function 13 determines a limit capacity of a current mail transmission by recognizing a limit capacity corresponding to a specified destination, a limit capacity corresponding to the transmission source terminal (self terminal), a limit capacity set by the user, etc.

The mail sending function 14 activates the moving image file edit function 21 and has it cut out individual scenes if the data amount of an attachment file exceeds the determined limit capacity. The mail sending function 14 sends a mail by attaching, to it, a resulting edited moving image file that consists of cut-out scenes and satisfies the limit capacity.

The company limit, capacity storage unit 15 is stored in advance with mail limit capacities of respective communication companies. That portion of mail address information which follows the mark “@” represents the name of a communication company. A communication company to which a terminal apparatus concerned is under contract can thus be known. For example, in the case of mail address information “xxx@ooo.ne.jp, ” a communication company can be identified from “ooo.”

Constituent elements relating to a moving image tile edit function of the invention are the moving image file edit function 21, the moving image file storage unit 22, the edit information storage unit 23, etc.

The moving image file edit function 21 provides a user interface through which one or plural scenes to be left preferentially are specified and priority ranks of those scenes are registered when a small moving image file is edited from one original moving image file stored in the moving image file storage unit 22 according to user manipulations while the original moving image file is reproduced and displayed.

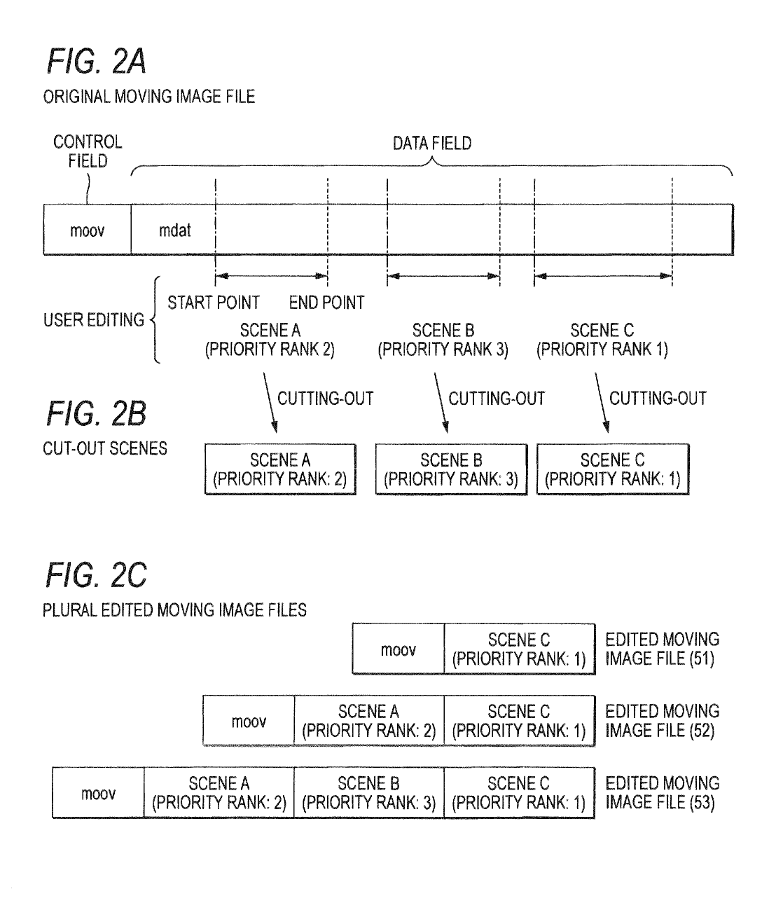

FIGS. 2A to 2C illustrate editing of a moving image file according to the embodiment of the invention. FIG. 2A shows the structure of one original moving image file which is stored in the moving image file storage unit 22 and consists control field moov and a data field mdat.

When this moving image file is reproduced and display the user can see a displayed moving image that corresponds to the data field mdat. By making user edit manipulations, the user cuts out one or plural scenes to be left by specifying an arbitrary start point(s) and end point(s) and gives priority ranks to the respective scenes without duplication.

FIG. 2B shows resulting cut-out scenes and their priority ranks. FIG. 2C shows the structure of plural edited moving image files obtained by automatically performing edit processing on the cut-out scenes (see FIG. 2B) according to those priority ranks. An edited moving image file 51 is a file whose data field contains only scene C having the first priority rank. An edited moving image file 52 is a file whose data field contains scenes A and C having the second and first priority ranks, respectively, that are arranged in the same time order as in the original moving image file. An edited moving image file 53 is a file whose data field contains scenes A, B, and C having the second, third, and first priority ranks, respectively, that are arranged in the same time order as in the original moving image file.

If the data amount of an attachment file specified by the user in sending a mail exceeds a limit capacity, one of plural edited moving image files each of which contains one or plural scenes selected according to priority order starting from a scene having the first priority rank is employed as an attachment file to be sent. Therefore, it is not necessary to generate substance data of all of the plural edited moving image files in advance; it is sufficient to generate substance data of an optimum edited moving image file that satisfies the limit capacity in sending a mail actually and to send it as an attachment file. Naturally, substance data of all of the plural edited moving image files may be generated in advance and stored in a memory.

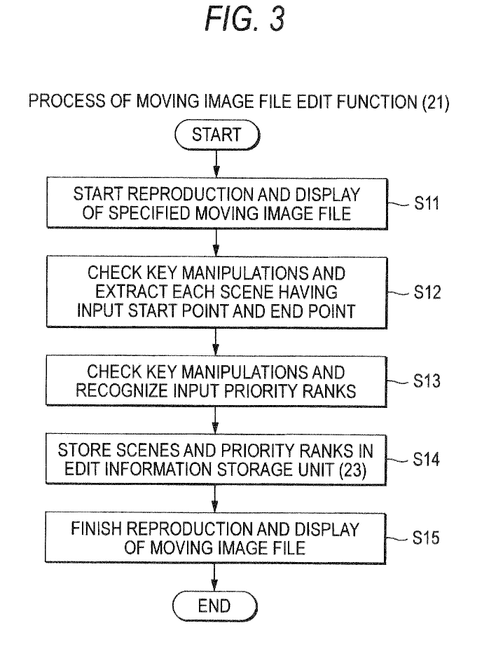

Next, the moving image file edit function 21 will be described in detail. FIG. 3 is a flowchart showing the operation of the moving image file edit function 21 of the terminal apparatus 100 according to the embodiment of the invention. The moving image file edit function 21 provides a user interface for user editing.

Another application function activates the moving image file edit function 21 after specifying a subject moving image file for the moving image file edit function 21.

The moving image file edit function 21 operates in response to user manipulations and hence takes edit work time. First, at step S11, reproduction and display of one original moving image file in the moving image file storage unit 22 that has been specified by the mail control function 11 is started. Looking at the displayed moving image, the user specifies start points and end points of scenes he or she wants to leave and gives priority ranks to the respective scenes by making key manipulations.

In response to the key manipulations by the user, the moving image file edit function 21 extracts corresponding positions in the original moving image file of each scene at step S12 and recognizes the priority ranks of the respective scenes. The moving image file edit function 21 stores the positions and the priority rank of each scene in the edit information storage unit 23 at step S14 and finishes the reproduction and display of the moving image file at step S15.

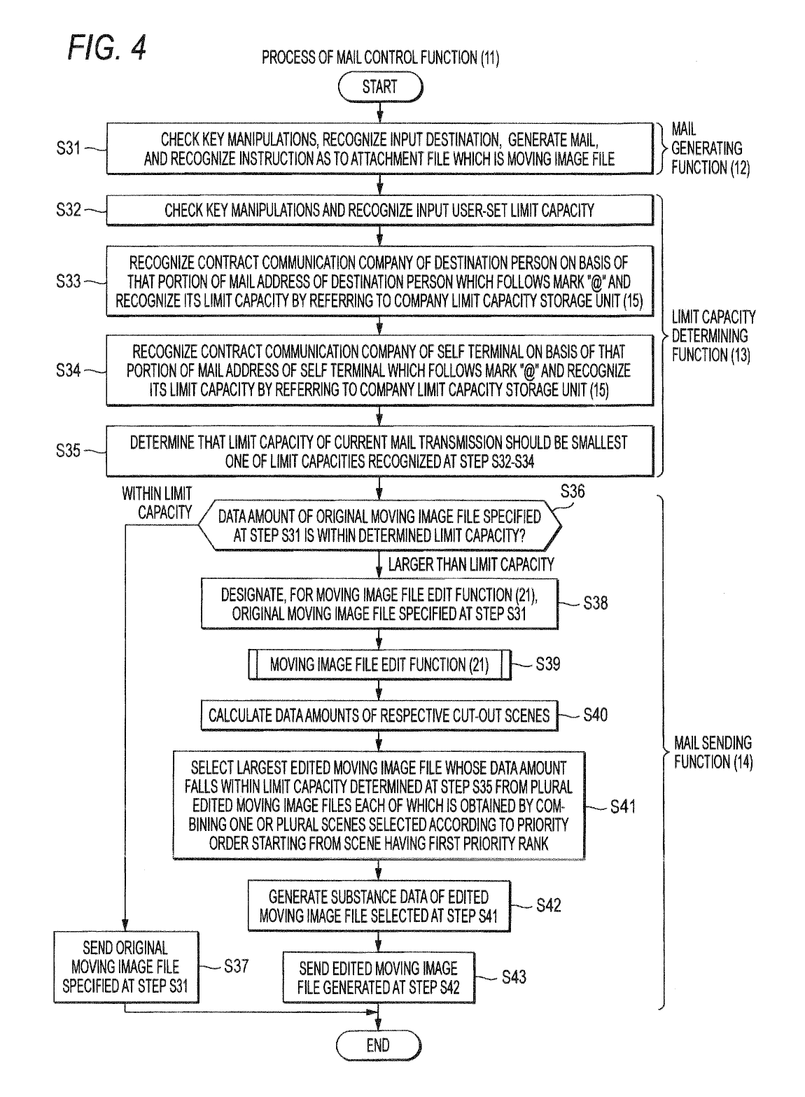

FIG. 4 is a flowchart showing the operation of the mail control function 11 of the terminal apparatus 100 according to the embodiment of the invention. As soon as the user starts mail generation, the mail control function 11 is activated and the mail generating function 12 starts to operate first. At step S31, the mail generating function 12 checks key manipulations by the user, recognizes an input destination, generates a mail, and recognizes an instruction as to an attachment file which is an original moving image file. As a result of the above processing which has been performed in response to the user manipulations, the destination person is determined and the user instruction as to the attachment file is recognized.

Then, the limit capacity determining function 13 starts to operate. At step S32, the limit capacity determining function 13 checks key manipulations by the user and recognizes an input user-set limit capacity. Although in the embodiment step S32 is executed every time a mail is generated, it may be executed when, for example, initial settings are made.

Since the destination person has been determined, at step S33 the limit capacity determining function 13 recognizes a contract communication company of the destination person on the basis of that portion of mail address information of the destination person which follows the mark “@” and recognizes its limit capacity by referring to the company limit capacity storage unit

At step S34, the limit capacity determining function 13 recognizes a contract communication company of the self terminal apparatus 100 on the basis of that portion of mail address information of the self terminal 100 which follows the mark “@” and recognizes its limit capacity by referring to the company limit capacity storage unit 15.

At step S35, the limit capacity determining function 13 determines that the limit capacity of the current mail transmission should be a smallest one of the limit capacities recognized at steps S32-S34.

Then, the mail sending function 14 starts to operate. At step S36, the mail sending function 14 judges whether the data amount of the original moving image file that was specified as the attachment file by the user at step S31 is within the determined limit capacity.

If the data amount of the original moving image file is within the limit capacity, at step S37 the mail sending function 14 sends, as it is, the original moving image file that was specified as the attachment file by the user at step S31. Then, the process is finished.

If the data amount of the original moving image file is larger than the limit capacity, at step 38 the mail sending function 14 designates, for the moving image file edit function 21, the original moving image file specified at step S31. At. step S39, the mail sending function 14 activates the moving image file edit function 21.

At step S39, as described above with reference to FIG. 3, the moving image file edit function 21 causes the user to cut out scenes and give priority ranks to the respective scenes and stores positions and the priority rank of each scene in the edit information storage unit 23.

At step S40, the mail sending function 14 refers to the edit information storage unit 23 and calculates data amounts of the respective cut-out scenes. At step S41, the mail sending function 14 selects a largest edited moving image file whose data amount falls within the limit capacity determined at step S35 from plural edited moving image files each of which is obtained by combining one or plural scenes selected according to the priority order starting from a scene having the first priority rank. The selection is done in the following manner. Whether the data amount of the edited moving image file falls within the limit capacity is judged one by one starting from an edited moving image file having a largest or smallest data amount. The selection processing is finished as soon as largest edited moving image file whose data amount falls within the limit capacity has been found. It is not necessary to calculate data amounts of the remaining edited moving image files.

At step S42, the mail sending function. 14 generates substance data of the thus-selected edited moving image file. At step S43, the mail sending function 14 sends the generated edited moving image file. Then, the process is finished.

In the embodiment of the invention, in a situation that the data amount of a file to be attached to a mail should satisfy various limitations such as a limitation relating to a transmission source contract communication company, a limitation relating to a destination person contract communication company, and a user-set limitation, a limit capacity of the intended mail transmission is determined on the basis of destination person information and transmission source information that are determined at the time of a mail transmission, the user-set limitation, etc. An edited moving image file that satisfies the thus-determined limit capacity is generated and sent. This procedure makes it possible to avoid such trouble that the mail cannot be sent because its data amount does not satisfy some limit capacity.

Among the above-mentioned various limit capacities, the limit capacity relating to the destination person contract communication company may be employed as a limit capacity of the intended mail transmission.

Although in the embodiment the limit capacities of the contract communication companies are stored in the company limit capacity storage unit 15 in advance, those limit capacities may be updated automatically using a proper system or updated by a user manipulation because they are subject to change.

Where the terminal apparatus of a destination person is a personal computer, for example, and is not a cell phone, in many cases that portion of its mail address which follows the mark “@” does not represent a communication company. In this case, the user may check a limit capacity of the destination person side and register it in advance by a user manipulation. In general, terminal apparatus other than cell phones have large limit capacities.

Where, for example, d limit capacity on the destination person side is unknown, the following procedure may be employed. The user tries to send a file and adjusts the data amount of file according to whether the mail has been sent successfully or not. The data amount of a mail that has been sent successfully is employed as a limit capacity. Once a limit capacity is registered, the user can send mails without any disadvantageous.

The invention can be applied to cell phones, PHS phones, PDAs, personal computers, and other terminal apparatus capable of communication.

The invention makes it possible to edit an attachment file of a mail so that it satisfies a smallest limit capacity among various limit capacities that occur depending on a mail communication situation, and thereby allows the user to send an attachment file reliably without the need for paying attention to a limit capacity in generating a mail.

What is claimed is:

1. A terminal apparatus comprising:
a limiting module that determines a limiting data size that is receivable data size by a destination terminal of a mail from the terminal apparatus;
a editing module that generates a plurality of scenes from an original file to be send when data size of the mail including the original file is larger than the limiting data size; and
a sending module that combines the generated scenes so that the data size does not exceed the limiting data size and sends the mail including the combined scene.

2. A terminal apparatus comprising:
a limiting module that determines a limiting data size that is smallest data size among a first data size that is receivable by a destination terminal of a mail from the terminal apparatus, a second data size that is sendable from the terminal apparatus and a third data size that is set by a user of the terminal apparatus;
a editing module that generates a plurality of scenes from an original file to be send when data size of the mail including the original file is larger than the limiting data size; and
a sending module that combines the generated scenes so that the data size does not exceed the limiting data size and sends the mail including the combined scene.

3. The terminal apparatus according to claim 1, wherein the editing module generates the scenes that are extracted from the original file according to an operation of the user and sets priorities of the generated scenes according to an operation of the user, and
the sending module combines the generated scenes according to the priorities so that the data size does not exceed the limiting data size and the combined scene includes a scene having the highest priority in the generated scenes.

4. The terminal apparatus according to claim 2, wherein the editing module generates the scenes that are extracted from the original file according to an operation of the user and sets priorities of the generated scenes according to an operation of the user, and
the sending module combines the generated scenes according to the priorities so that the data size does not exceed the limiting data size and the combined scene includes scene having the highest priority in the generated scenes.

5. The terminal apparatus according to claim 1, wherein the limiting data size is set by a communication company to which the destination terminal is under contract.

6. The terminal apparatus according to claim 3, wherein the limiting data size is set by a communication company to which the destination terminal is under contract.

7. The terminal apparatus according to claim 2, wherein the first data size is set by a communication company to which the destination terminal is under contract, and
the second data size is set by a communication company to which the terminal apparatus is under contract.

8. The terminal apparatus according to claim 4, wherein the first data size is set by a communication company to which the destination terminal is under contract, and
the second data size is set by a communication company to which the terminal apparatus is under contract.

9. A data transmitting method comprising:
determining a limiting data size that is receivable data size by a destination terminal of a mail from the terminal apparatus;
determining whether or not data size of the mail including a original file to be sent is larger than the limiting data size;
generating a plurality of scenes from the original file when the data size is larger than the limiting data size;
combining the generated scenes so that the data size does not exceed the limiting data size; and
sending the mail including the combined scene.

10. The data transmitting method according to claim 9 further comprising:
allowing a user of the terminal apparatus to determine a plurality of pars of the original file so as to generate the plurality of scenes; and
allowing the user to set priorities of the generated scenes,
wherein the combined scene is obtained by combining the generated scenes according to the priorities so that the data size does not exceed the limiting data size and the combined scene includes a scene having the highest priority in the generated scenes.
